(19) United States
(12) Patent Application Publication
(10) Pub. No.: US 2020/0148517 A1
(43) Pub. Date: May 14, 2020

(54) VEHICLE LIFTING PLATFORM

(71) Applicant: Otto Nussbaum GmbH & Co. KG, Kehl-Bodersweier (DE)

(72) Inventors: Steffen NUSSBAUM, Strasbourg (FR); Benjamin SCHANZ, Renchen (DE)

(73) Assignee: Otto Nussbaum GmbH & Co. KG, Kehl-Bodersweier (DE)

(21) Appl. No.: 16/679,756

(22) Filed: Nov. 11, 2019

(30) Foreign Application Priority Data
Nov. 13, 2018 (DE) 102018128429.2
May 23, 2019 (EP) 19176285.5

(51) Int. Cl. B66F 7/28; G01G 19/02

(52) U.S. Cl. CPC B66F 7/28; G01G 19/02

(57) ABSTRACT

In order to improve the safety of a lifting platform with respect to risk of a vehicle falling, provision is made, in a lifting platform having carrying arms, which can be vertically adjusted by a lifting mechanism, for raising the vehicle and having carrying plates, which are arranged at a free end of the carrying arms, for carrying the vehicle to be lifted, for a sensor arrangement having a plurality of pressure sensors which are arranged distributed over a bearing surface of the carrying plates to be installed on each of the carrying plates and for a display which displays a pressure distribution over the bearing surface of the respective carrying plate to be associated with each carrying plate.

### INCORPORATION BY REFERENCE

The following documents are incorporated herein by reference as if fully set forth: German Patent Application No. DE 10 2018 128 429.2, filed Nov. 13, 2018; and European Patent Application No. EP 19176285.5, May 23, 2019.

### BACKGROUND

The present invention relates to a lifting platform for vehicles having carrying arms, which can be vertically adjusted by a lifting mechanism, for raising the vehicle and having carrying plates, which are arranged at a free end of the carrying arms, for carrying the vehicle to be lifted, where the carrying plates comprise means for recording a weight force which acts on the carrying plates.

Lifting platforms having carrying arms are widespread since, as a result of the variable carrying arms, both large and small vehicles can be held and raised. In this case, the vehicles are held on so-called carrying plates which are arranged at the free ends of the carrying arms. These carrying plates must be positioned beneath the holding points of the vehicle which are prescribed by the vehicle manufacturer, by pivoting in and adjusting the length of the carrying arms, in order to ensure safe raising. A frequent cause of vehicles falling from lifting platforms is the incorrect holding or incorrect positioning of the carrying plates below the vehicle.

Various measures have been proposed in order to identify incorrect holding of a vehicle at an early stage. For example, EP 2 708 489 A1 describes that strain gauges which serve to determine a weight force which acts on the carrying arm can be provided in the carrying arms. The sensors are connected to a computer which checks the total load and the load distribution. If the ascertained weight forces per carrying arm or overall are too high or there is an excessively non-uniform load distribution, the computer can suppress a lifting process.

In addition, it has also been proposed to provide sensors directly in the carrying plates instead of on the carrying arms. For example, DE 10 2009 051 702 B3 describes a carrying plate with an integrated weight measuring apparatus in the form of a fluid-filled cavity and a pressure measuring device which is connected to it. The weight force acting on the carrying plate leads to an increase in pressure. This can be displayed on a display which is located at the circumferential edge of the carrying plate.

DE 10 2007 053 757 B3 discloses a carrying plate which rests on a liquid-filled chamber, the fluid pressure of which is measured for the purpose of ascertaining an applied weight force.

In a similar manner, EP 1876136 B1 describes a carrying plate with a sensor, which is integrated in the holder of said carrying plate, for measuring weight force. However, these apparatuses cannot be used to establish whether a weight force acts eccentrically on the carrying plate and therefore could possibly cause the vehicle to slip off from a carrying plate.

EP 631976 A1 describes a lifting platform having carrying arms in which switches, with which tilting of a carrying plate due to non-uniform weight loading is intended to be identified, are arranged in the carrying plates.

Finally, EP 2754636 B1 describes a lifting platform having carrying arms, the carrying plates of which have a star-shaped carrying structure in the interior, it being possible for a deformation of the carrying structure due to weight forces which are applied to it to be measured on said star-shaped carrying structure by means of four strain gauges. This also makes it possible to a certain extent for a non-uniform loading of the carrying plates to be indentified.

### SUMMARY

An object of the present invention is to further improve the safety of a lifting platform in respect of the risk of a vehicle falling and in particular to allow the operator to identify improper and, respectively, dangerous holding of a vehicle in a simple and intuitive manner.

The object is achieved by a lifting platform having one or more features of the invention. Advantageous refinements can be found below and in the claims.

In the case of a lifting platform of the kind mentioned at the outset, the invention makes provision for a sensor arrangement comprising a plurality of pressure sensors which are arranged distributed over a bearing surface of the carrying plates to be installed on each of the carrying plates and for a display to be associated with each carrying plate, which display displays a pressure distribution over the bearing surface of the respective carrying plate. By way of the loading of each individual supporting plate and primarily the distribution of the load over each individual carrying plate being optically shown to the operator, said operator can immediately identify whether the vehicle has been correctly held or whether there is possibly a risk that the vehicle could slip off from one of the carrying plates.

In a preferred embodiment, the display which is associated with a carrying plate is arranged on the bottom side of the associated carrying plate, that is to say the display points downward. Therefore, a mirror image of the force distribution over the bearing surface of the carrying plate can be shown and displayed directly to an operator on the bottom side of the carrying plate. An operator, when he steps beneath a raised vehicle, immediately identifies whether the load is uniformly distributed over the carrying plates or whether one of the carrying plates is loaded on one side such that there could possibly be a risk of the vehicle slipping off.

In a similar way, the display can also be arranged on the bottom side of the carrying arm which is associated with the carrying plate, instead of on the bottom side of the associated carrying plate. However, a signal connection from the carrying plate to the respective carrying arm is required in this case.

In particular, provision can be made within the scope of the present invention for the displays to correspond substantially to the bearing surface of the associated carrying plates in respect of shape and size of surface area. In other words, the individual displays each display a shown, preferably mirror-inverted image of the bearing surface of the associated carrying plate and the load which is distributed over said bearing surface. This allows particularly intuitive and simple display of the load distribution.

The displays can preferably be designed as illuminated displays, in particular as multicolor illuminated displays. Therefore, the operator, when he steps beneath the lifting platform, can establish the load distribution on the carrying plates irrespective of the lighting conditions beneath the lifting platform. A multicolor illuminated display allows the load distribution to be shown in a particularly intuitive manner by way of using different colors for surface pressure forces of different levels.

In a preferred embodiment, the displays consist of a large number of lighting means, in particular light-emitting diodes, which are combined to form a planar illuminated display. Instead of individual light-emitting diodes, the display can also be formed by any other planar illuminated display, for example a back-lit LCD display.

Similarly, it is possible for the sensor arrangement to be designed as a matrix sensor having a large number of sensor cells which are arranged in a matrix-like manner. Here, it is particularly advantageous when the display has a preferably multicolor lighting means, in particular a multicolor light-emitting diode, for each sensor cell, and the lighting means are arranged in the matrix sensor of corresponding matrix form. Therefore, each individual lighting means, and therefore each individual lighting point in the matrix arrangement, corresponds to an associated sensor cell and shows the pressure force which is measured by this sensor cell, for example by way of different colors or a different luminosity. Therefore, a user intuitively identifies the load distribution over the bearing surface of the carrying plate.

In one embodiment of the invention, the sensor cells can be designed as piezoresistive sensors. Therefore, the pressure-dependent resistance of the individual sensor cells can be determined by simple resistance measurement. In addition, sensor cells of this kind are of simple and compact construction.

According to a particularly preferred embodiment, the sensor arrangement is designed as a film-type sensor. Said film-type sensor comprises at least two films to which conductor tracks are applied, where the conductor tracks of the two films cross over each other. Here, the crossover points form the sensor cells of the sensor arrangement. A film-type sensor of this kind is simple in respect of production and robust in respect of handling.

The carrying plates are preferably designed with a plate-like carrying structure, the top side of which is covered by an in particular rubber-elastic or slip-resistant cover, in particular an elastomer support. Here, the sensor arrangement is arranged between the carrying structure and the cover. The cover ensures secure bearing on the vehicle and protects the sensor arrangement situated beneath it. Nevertheless, a precise pressure distribution over the bearing surface of the carrying plate can be measured due to the elastic properties of the cover.

Within the scope of the present invention, various measurement methods can be used for measuring the weight force and weight distribution applied to the carrying plate, amongst others piezoelectric, magnetoelastic, capacitive or magnetically inductive force measurement. Said measurement methods are based substantially on a deformation of a material which is recorded by measurement.

In the case of the piezoelectric force measurement, a charge distribution Q, which is proportional to the force and can be measured, is created in a piezoceramic element by the action of force. This measurement method allows, in particular, dynamic measurements.

In the case of the magnetoelastic force measurement, a change in the magnetic permeability μ of a material under the action of force is recorded. This can be performed using two coils by way of a change in the magnetic flux which is transmitted from a primary coil to a secondary coil being measured. This measurement method is suitable particularly for static measurements.

In the case of the capacitive force measurement, a sensor is used which operates on the basis of the change in the electrical capacitance of an individual capacitor or of a capacitor system. The capacitance is proportional to the distance between the capacitor plates.

A further measurement principle which can be particularly preferably used within the scope of the present invention is the inductive distance measurement between a coil and a metal plate (magnetically inductive force measurement). The change in the distance has an effect on the inductance which, in turn, can be evaluated in electrical terms.

In a preferred embodiment of the invention, a deformation of an elastomer support of the carrying plate is recorded. To this end, the carrying plates have a plate-like carrying structure and an, in particular rubber-elastic, support which is arranged above said plate-like carrying structure, and the sensor arrangement is designed to detect a deformation of the elastic support under the action of force.

To this end, a metal element, in particular a disk-like element, for example an intermediate sheet, can preferably be embedded into the elastic support of the carrying plates, and the sensor arrangement can be designed to detect a change in distance between the element and the carrying structure under the action of force. A metal element of this kind firstly ensures planar pressure distribution over the carrying plate. Secondly, the metal element can also be used as a reference point for an inductive distance measurement within the scope of the present invention. The material of the elastomer support which is located between the carrying structure of the carrying plate and the intermediate sheet is deformed depending on an applied force. For measurement purposes, the change in distance between the carrying structure of the carrying plate and the intermediate sheet is therefore measured under the action of force, that is to say the change in thickness of the elastomer layer which is located therebetween.

In order to guide the force onto the sensor, spring elements, such as plate springs or helical plate springs for example, could be used as an alternative or in addition to said elastomer support.

For the purpose of measuring the change in distance, provision can be made for the sensor arrangement to have at least one coil and for a measuring arrangement to be provided for measuring a change in the inductance of the coil on account of a change in distance between the coil and the metal element.

For the purpose of measuring a pressure force distribution, the sensor arrangement can preferably comprise a plurality of coils which are arranged offset in the circumferential direction, in particular coils which are printed onto a printed circuit board which is arranged between the elastic support and the carrying structure.

In a further embodiment based on a capacitive force measurement, two conductive plates which are spaced apart by way of an insulating material can be used, where the insulating material serves as a spring. A simple variant would be the use of a printed circuit board with copper areas, where the board material serves as a spring. The advantage of this concept is that no elements of the carrying plate are used directly for force measurement.

A typical board material is FR4, a composite material comprising epoxy resin and glass-fiber fabric. However, the elasticity of said board material and therefore the load-dependent change in thickness are relatively low here, with the result that the electrical capacitance measurement has to be correspondingly sensitive. In order to achieve a change which is as large as possible, a supporting surface which is as small as possible would be advantageous. As an alternative, other board materials with a higher elasticity, such as polyamide for example, can be used.

For the purpose of determining the capacitance of the plate capacitor, different measurement methods can be used, including
Capacitive Sensing (CPS): charge capacitor with a constant current and output the charging or discharging time as a frequency signal by means of a comparator. The resulting frequency can then be measured and the change in frequency is proportional to the change in capacitance. By increasing the measurement time, the resolution can be improved and the influence of disturbing factors can be reduced by taking an average value.
Capacitive Voltage Divider (CVD): relative capacitance measurement by means of a capacitive voltage divider and measurement of the resulting voltage with an ADC. This measurement principle is highly suitable for quick and relative capacitance measurement. The resolution depends directly on the accuracy of the ADC used.

Provision can also be made within the scope of the present invention for the sensor arrangements and associated displays of the carrying plates to be battery-operated. The batteries can, in particular, likewise be accommodated within the carrying plates or the carrying structure thereof, so that the carrying plates operate as autonomous units and no cable connection to the carrying arms is required. This allows, firstly, retrofitting of the carrying plates to existing lifting platforms and, secondly, there is no need for sensitive electrical lines which could constitute a fault source, this allowing operation of the lifting platform without susceptibility to faults.

Within the scope of the present invention, in a preferred development, a total weight force which is applied to the associated carrying plate can be ascertained in each case from the signals generated by the sensor arrangements and preferably wirelessly transmitted to a central control arrangement. This allows comparison of the load which is absorbed by the individual carrying arms, so that it is possible to determine whether the vehicle has been correctly held at all bearing points. If impermissibly high deviations between the individual carrying arms are established, a fault signal can be output and/or raising of the vehicle can be suppressed.

Within the scope of the invention, provision can also be made for the pressure distribution which is displayed on the display or the values for the surface loading, which values are ascertained by the sensor arrangement, to be stored and saved in the form of a log for a certain period of time. This renders it possible to subsequently comprehend the holding situation of a vehicle in the event of a fault or an accident. Provision can likewise be made for the signals which are measured by the sensor arrangement or derived therefrom to be transmitted to a central point and further processed or buffer-stored there. The transmission can be carried out, in particular, via a wireless interface. The operating state of the lifting platform can be monitored and operating and operator-control parameters can be recorded and logged in the central point.

The invention also relates to a carrying plate for a vehicle lifting platform having a sensor arrangement comprising a plurality of pressure sensors, which are arranged distributed over a bearing surface of the carrying plate, for recording a weight force acting on the carrying plate and also the distribution of said weight force over the bearing surface of the carrying plate. The carrying plate also has a display which is preferably arranged on the bottom side and displays a pressure distribution over the bearing surface.

### BRIEF DESCRIPTION OF THE DRAWINGS

Further properties and advantages of the invention are described on the basis of the exemplary embodiments and the appended drawings, in which:

FIG. 1 shows a 2-pillar lifting platform having four carrying arms, at the free ends of each of which a carrying plate is arranged,

FIG. 2 shows a section through a carrying plate in a first exemplary embodiment, which carrying plate can be used in the lifting platform in FIG. 1,

FIG. 3 shows a basic drawing of a pressure-sensitive film-type sensor, as can be used in a carrying plate,

FIG. 4 shows a section through a carrying plate in a second exemplary embodiment,

FIG. 5 shows a section through an elastomer support for the carrying plate from FIG. 4,

FIG. 6 shows an isometric view of the elastomer support from FIG. 5, and

FIG. 7 shows a block diagram of a sensor arrangement, display device and associated control circuit.

### DETAILED DESCRIPTION

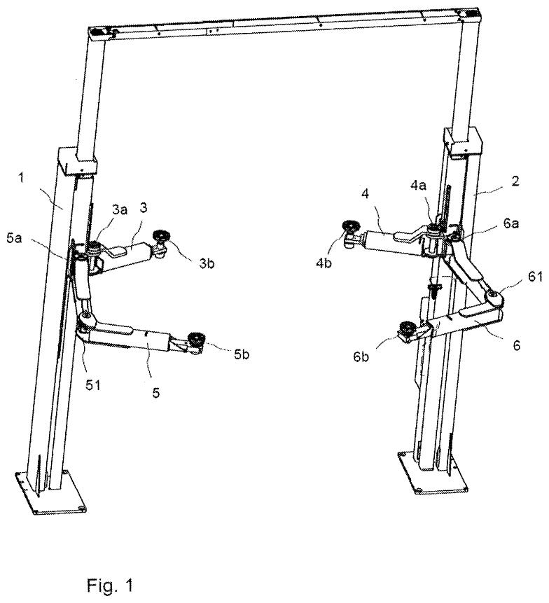

FIG. 1 illustrates a lifting platform having two lifting pillars 1, 2, to each of which two carrying arms 3, 5 and, respectively, 4, 6 are pivotably articulated. The carrying arms 3, 4, 5, 6 are vertically adjustable, that is to say they can be raised and lowered. The lifting driving inside the lifting pillar 1, 2 is carried out in a manner known per se, for example by means of cylinder/piston assemblies, by means of a threaded spindle or by means of a chain drive. The present invention is not restricted to two pillar lifting platforms, but rather can be used in all types of lifting platforms with carrying arms, such as 4-pillar lifting platforms or post-type lifting platforms.

The carrying arms 3, 4 form a front carrying arm pair, that is to say serve for raising the front half of the vehicle, and the carrying arms 5, 6 form a carrying arm pair for the rear half of the vehicle. The carrying arms 3 and 5 of the left-hand vehicle side are arranged in a mirror-inverted manner with respect to the carrying arms 4, 6 of the right-hand vehicle side. The carrying arms are each pivotably mounted on their associated lifting pillar 1, 2 via a pivot bearing 3a, 4a, 5a, 6a, with the result that they can be pivoted beneath a vehicle parked between the lifting pillars 1, 2 and can be moved to the holding points on the bottom of the vehicle.

Carrying plates 3b, 4b, 5b, 6b are arranged at the free ends of the carrying arms 3, 4, 5, 6 and come into contact with the vehicle as the carrying arms are raised. The carrying plates 3b, 4b, 5b, 6b can also be vertically adjustable to a certain extent with respect to the associated carrying arms 3, 4, 5, 6 by means of a thread.

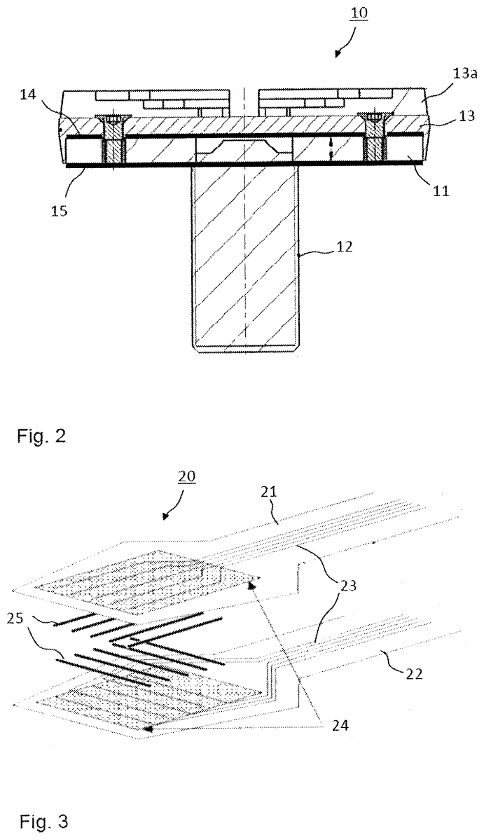

FIG. 2 illustrates, by way of example, a carrying plate 10. Said carrying plate comprises a plate-like carrying structure 11 which is fastened in a corresponding holder to a carrying arm by means of a pin or threaded bolt 12 which is arranged on the bottom side of said carrying structure. A cover 13 with a top side 13a with slip-resistant structuring is located on the top side of the carrying structure 11. The cover 13 is screwed to the carrying structure 11. Said cover is composed of a rubber-elastic material which ensures secure bearing on a vehicle. A sensor arrangement 14 in the form of a film-type sensor having a large number of pressure-sensitive sensor cells which are distributed over the sensor surface is located between the support 13 and the carrying structure 11. The film-type sensor 14 allows the measurement of a pressure force distribution over the bearing surface of the carrying plate 10. An illuminated display 15, which serves to show and display a mirror-inverted image of the pressure distribution which is measured by the film-type sensor 14, is located on the bottom side of the carrying structure 11.

In the exemplary embodiment, the illuminated display 15 consists of a large number of individual lighting points in the form of multicolor light-emitting diodes and extends over the entire available bottom side of the carrying plate (that is to say apart from that area which is taken up by the pin). The lighting points can be individually controlled depending on the pressure force measured directly across them. Control is performed by means of an evaluation electronics system, not shown in any detail here, which can be accommodated, for example, inside a cavity in the pin or bolt 12.

Showing the pressure force distribution which is measured over the supporting surface of the carrying plate 10 by means of an illuminated display 15 allows an operator to check, before he steps beneath a raised vehicle, whether the vehicle has been correctly held at the support points. If the supporting force is concentrated in a region at the edge of the carrying plate 10 for example, the vehicle could slip and fall while work is being performed. A situation of this kind can be easily identified and corrected in order to avoid accidents. In this manner, measuring and showing the pressure force distribution on the individual carrying plates 10 contributes to increasing the operational safety.

In addition, a battery-assisted power supply for autonomously operating the illuminated display and also a compact transmitter, with which measured pressure force signals can be transmitted to a central control arrangement in order to in this way allow the loading on the individual carrying arms to be compared, can be accommodated in the bolt or pin 12.

In the exemplary embodiment, the carrying arms of the rear pair of carrying arms are designed, without the invention being restricted to this, as double-jointed arms, whereas the carrying arms 3, 4 of the front pair of carrying arms are embodied as conventional, rigid carrying arms. Therefore, the carrying arms 3, 4 can be pivoted only about their respective articulation point 3a, 4a on the pillars 1, 2 and can also be telescopically adjusted in terms of length (2-fold telescopically length-adjustable). The rear two carrying arms 5, 6 are provided with an additional bending joint 51, 61, with the result that the respective carrying arm 5, 6 can be bent in its pivot plane which is defined by the pivot joint 5a, 6a. The rear carrying arms 5, 6 are also likewise telescopically length-adjustable. This arrangement renders it possible to hold vehicles in a highly variable manner and, in particular, to hold vehicles of different vehicle lengths.

The film-type sensor 14 which is arranged beneath the plastic part which forms the cover 13 of the carrying plate 10 serves to identify and, respectively, to measure the point loading over the supporting surface of the carrying plate. An example of a film-type sensor of this kind is schematically illustrated in FIG. 3. The film-type sensor 20 shown in said figure consists of two thin polyester films 21, 22 onto which conductor tracks 23 are printed. In the respective measurement region 24 of the films 21, 22, the conductor tracks 23 are fanned out and run perpendicular in relation to one another, that is to say in the longitudinal direction on the film 21 and in the lateral direction on the film 22, with the result that a matrix arrangement is created between the films 21, 22 which are laid one on the other.

A pressure-sensitive, in particular piezoresistive, coating 25 is applied along the conductor tracks 23 on the inside of the two films 21, 22. On account of this coating, there is a pressure force-dependent variable resistance at the crossing points of the matrix between the conductor tracks 23 which cross each other. Each crossing point of the matrix therefore forms a sensor cell or a sensor element (pressure force sensor). By means of a processor-controlled multiplexer, each crossing point of the matrix can be wired and the cell resistance thereof can be measured. The wiring by means of the evaluation electronics system prevents the cells from influencing one another. The shape and the matrix geometry of the film-type sensor 20 can be matched to the respective application. For application in the carrying plate 10, the conductor tracks can also run, for example, in the form of concentric rings on one film and radiantly in the radial direction on the other film. The sensor density can be prespecified by means of the distance between the printed conductor tracks 23. The number of sensor cells distributed over the sensor matrix can be several hundred to several (tens of) thousand sensors.

The lighting points of the illuminated display 15 are arranged on the bottom side of the carrying plate in accordance with the distribution of the sensor cells over the film-type sensor 14, with the result that each sensor cell corresponds to a lighting point. However, it is likewise also possible to combine a plurality of sensor cells and assign them to one lighting point given a corresponding high cell density. For simplification purposes, the illuminated display 15 can also be subdivided into segments and controlled segment by segment. Due to the optical indication of the pressure force distribution over the holding surface of the carrying plate, the operator is able to check for correct holding of the raised vehicle at any time. Summing over the pressure force which is measured by the individual sensor cells allows a weighing function of the load which is absorbed overall by the carrying plate. This value can be wirelessly transmitted to a base station for the purpose of comparing the loads resting on the various carrying arms.

In a development of the invention, the pressure distribution displayed on the display or the values for the surface loading, which values are ascertained by the sensor arrangement 15, can be stored and saved in the form of a log for a certain period of time. This renders it possible to subsequently comprehend the holding situation of a vehicle in the event of a fault or an accident. It is likewise possible for the signals which are measured by the sensor arrangement 15 or derived therefrom to be transmitted to a central point and further processed or buffer-stored there. The transmission can be carried out, in particular, via a wireless interface. The operating state of the lifting platform can be monitored and operating and operator-control parameters can be recorded and logged in the central point.

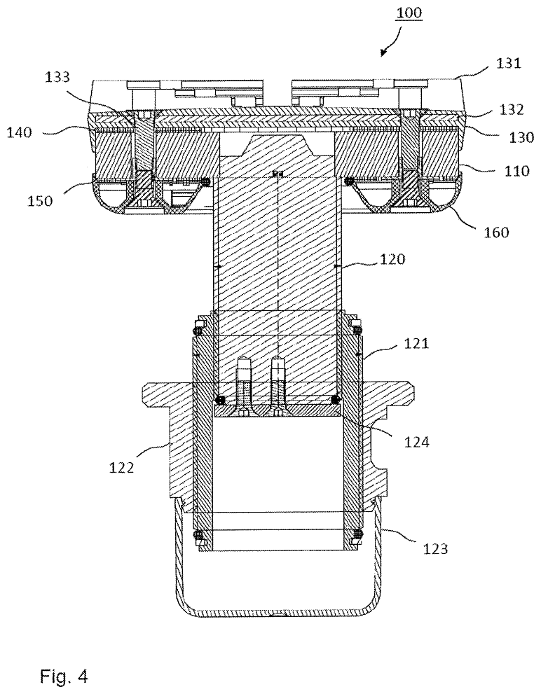

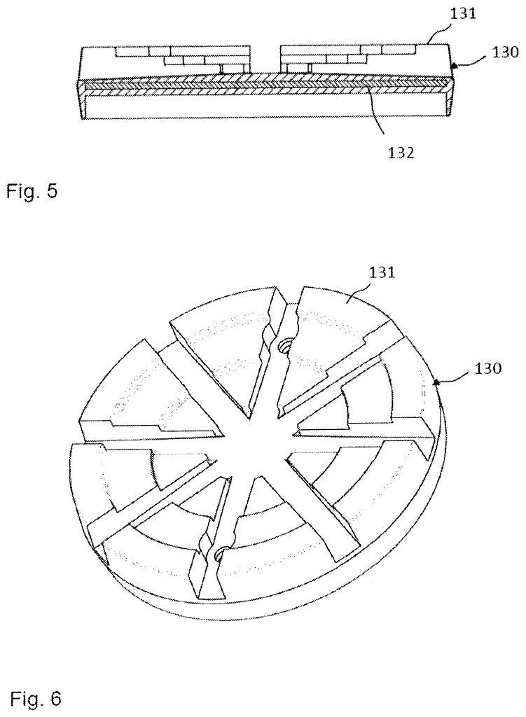

A further exemplary embodiment of the invention is shown in FIGS. 4 to 7. The carrying plate 100 shown in section in FIG. 4 has a plate-like carrying structure 110 which is referred to as a holding plate. A threaded bolt 120 (for example M42x3) is centrally fastened to the bottom side of said holding plate. For the purpose of telescopic vertical adjustment, said threaded bolt is inserted into a threaded bushing 121 which in turn has an external thread (for example M56x3) by way of which it is screwed into a telescopic bushing 122 with a corresponding internal thread. The telescopic bushing 122 is provided with a protective cap 123 on the bottom side. A disk 124 which is screwed against the bottom side of the threaded bolt 120 secures the threaded bolt in the lower, radially extended region of the threaded bushing 121, with the result that the threaded bolt 120 can be screwed out or in with respect to the threaded bushing 121 in terms of height only within the permissible adjustment range, but cannot be removed. FIG. 4 illustrates the maximum upwardly screwed-out position of the threaded bolt 120 in the threaded bushing 121.

An elastomer support 130 is arranged on the top side of the holding plate 110 and engages around the edge of the holding plate 110 and is screwed to the holding plate 110 from the top side by means of two countersunk screws 133. The elastomer support 130 has, on the top side, slip-resistant profiling in the form of segmented stepped rings 131 which become higher toward the outside and the arrangement of which can be seen more clearly in FIG. 6.

In the exemplary embodiment, without the invention being restricted to this, the elastomer support consists of acrylonitrile-butadiene rubber (NBR) which is also known by the trade name Perbunan. This synthetic rubber is extremely resistant to the effect of fuels and oils, in particular hydraulic oils, greases and other aliphatic hydrocarbons, acids and alkalis. Good physical values, such as high abrasion resistance and stability and a favorable temperature resistance of −25° C. to +100° C. for example, make the material ideally suitable for use in automotive workshops and here, in particular, for a support element for holding heavy motor vehicles. Further materials which come into consideration for said use are, for example, HNBR (hydrogenated NBR) or Viton (fluorinated rubber).

The elastomer support shown has a Shore hardness (Shore A) of 70±5 Shore. Given a load of 1250 kg and a diameter of the carrying plate of 120 mm, a change in distance in the region of 5% results in this case. This provides a good basis for an inductive distance measurement with a sufficient change in measurement value even given relatively small loads.

The carrying plate 100 comprises a first printed circuit board 140, which is arranged between the elastomer support 130 and the holding plate 110, and a second printed circuit board 150 which is fitted to the bottom side of the holding plate 110. A transparent cover 160 protects the lower printed circuit board 150 and its components from mechanical influences and dirt. The printed circuit boards 140 and 150 are connected to one another in terms of signaling by means of a printed circuit board connector or plug-in connector which is routed through an elongate hole in the carrying structure 110. The printed circuit board 140 is composed of a conventional printed circuit board material FR4, a composite material comprising epoxy resin and glass-fiber fabric. Due to the large supporting surface and the printed circuit board material used, the supporting force can be transferred without problems by means of the printed circuit board 140. The printed circuit board 140 comprises a sensor arrangement for measuring a pressure force distribution. The second printed circuit board 150 contains, firstly, an evaluation electronics system and power supply for the sensor arrangement which is located on the upper printed circuit board 140, and secondly a display in the form of a plurality of two-color light-emitting diodes 151.

The measurement principle underlying the second exemplary embodiment is based on the elastomer support 130 being more or less deformed by a load. In the second exemplary embodiment, the invention makes use of the deformation being dependent on the applied pressure force on account of the material composition. Therefore, the sensor arrangement is designed to measure the deformation of the elastomer support 130. This can be performed capacitively or, as in the present exemplary embodiment, inductively.

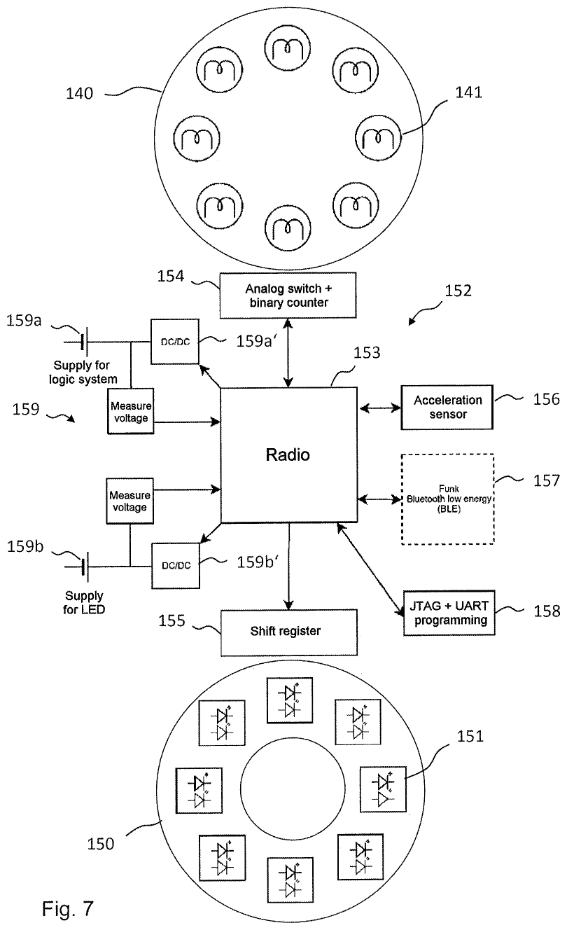

A metal intermediate sheet 132 is embedded in the interior of the elastomer support 130. The intermediate sheet 132 ensures, firstly, a planar pressure distribution over the holding plate 110. The intermediate sheet 132 also serves as a reference point for a distance measurement. The material of the elastomer support which is located between the carrying structure 110 of the carrying plate and the intermediate sheet 132 is deformed depending on an applied force. For measurement purposes, the change in distance between the carrying structure 110 and the intermediate sheet 132 under the action of force, that is to say the change in thickness of the elastomer layer located therebetween, is measured. The change in the distance has an effect on the inductance of a coil which in turn can be evaluated in electrical terms. The sensor arrangement and the evaluation electronics system are illustrated in FIG. 7.

A total of eight printed coils 141 are applied with a circular arrangement to the upper printed circuit board 140. Said printed coils are connected to the evaluation electronics system 152, which is located on the lower printed circuit board 150 and can be realized in the form of integrated circuits, by means of the plug-in connection (not shown) which runs through the carrying plate 110. A total of eight two-color light-emitting diodes 151 are also located with a likewise circular arrangement on the lower printed circuit board 150. Each of the light-emitting diodes 151 is assigned to one of the printed coils 141 and serves as a display for the supporting force which is ascertained by means of this coil. The pressure force is therefore measured and displayed by means of eight sectors which correspond to the segmentation of the stepped rings 131 of the elastomer support 130.

The evaluation electronics system 152 comprises a microcontroller 153, an integrated control module with an analog switch and a binary counter, an integrated control module with shift registers, an acceleration sensor 156, a transmitter/receiver module 157 for wireless data transmission, for example according to the Bluetooth or Zigbee standard, and a programming interface 158 according to the JTAG and/or UART standard.

The inductance of the coils 141 is controlled or measured by means of the analog switch module 154 which also comprises binary counters, with the aid of which a signal frequency can be measured by counting over defined time intervals. The LEDs 151 are controlled in a multiplexed manner, that is to say with a time delay by means of the shift registers 155 which serve as port extenders.

The power supply 159 is provided by means of two batteries 159a, 159b, for example 3 V lithium button cells, one 159a of which serves for supplying the evaluation electronics system 152 and the other 159b of which serves for supplying the LEDs 151 since the latter have the highest power consumption during operation. Each of the batteries has a controlled DC/DC converter 159a′, 159b′ in order to reduce the voltage to a lower value of, for example, 2 V. The DC/DC converters 159a′, 159b′ are likewise controlled by the microcontroller 153 which measures the respective battery voltage and accordingly controls the associated DC/DC converter 159a′, 159b′.

The printed coils 141 which change their inductance depending on the distance from the intermediate sheet 132 in the support 130 are used for signal recording purposes. A modified Colpitts oscillator is used in order to measure the change in inductance. In order to keep the circuit complexity and the required number of components and signal lines low, four coils are connected to the oscillator by means of the analog switch 154. This also makes it possible to prevent the coils 141 from influencing each other. In order to be able to evaluate the sensor signal as easily as possible with the microcontroller 153, use is made of a counter module 154 which measures the oscillator oscillations. The output signal from the counter module 154 can be directly evaluated using an input capture of the microcontroller 153. The acceleration sensor 156 is used in order to identify a movement and therefore to start the force measurement. This acceleration sensor 156 can also be used to identify the position and therefore, for example, to also identify whether the carrying plate 110 is installed horizontally.

One of the two-color LEDs 151 is used for each sector for display purposes. In order to save pins on the microcontroller 153, shift registers 155 are used as port extenders for control purposes. Since the voltage supply 159 cannot drive much current, only one of the LEDs 151 should always be active and the control should therefore be performed in a multiplexed manner. This extends the service life of the battery 159b. The intensity of the LEDs can be reduced by means of additional PWM control.

The applied-load-dependent measurement values which are ascertained for each sector can be transmitted to a central computer via the radio interface 157 or can be transmitted to remote servers via a network, where the measurement values are further evaluated and stored.

1. A lifting platform for vehicles, the lifting platform comprising:
a lifting mechanism (1, 2);
carrying arms (3, 4, 5, 6), which are vertically adjustable by the lifting mechanism (1, 2), for raising the vehicle, the carrying arme including carrying plates (3a, 4a, 5a, 6a; 10), which are respectively arranged at a free end of each of the carrying arms (3, 4, 5, 6), for carrying the vehicle to be lifted, the carrying plates (3a, 4a, 5a, 6a; 10; 100) comprise a weight force sensor arrangement (14, 20) that records a weight force which acts on the carrying plates (10; 100);
the sensor arrangement (10, 20) comprises a plurality of pressure sensors (141) which are arranged distributed over a bearing surface of the carrying plates (3a, 4a, 5a, 6a; 10; 100) installed on each of the carrying plates (3a, 4a, 5a, 6a; 10; 100); and
a respective display (15; 151) which displays a pressure distribution over the bearing surface of each of the respective carrying plates (3a, 4a, 5a, 6a; 10; 100) is associated with each said carrying plate (3a, 4a, 5a, 6a; 10; 100).

2. The lifting platform as claimed in claim 1, wherein the respective displays (15; 151) which are associated with each said carrying plate (3a, 4a, 5a, 6a; 10; 100) are arranged on a bottom side of the associated carrying plate or on a bottom side of the carrying arm (3, 4, 5, 6) which is associated with the associated carrying plate (3a, 4a, 5a, 6a; 10, 100).

3. The lifting platform as claimed in claim 1, wherein the displays (15; 151) comprise illuminated displays.

4. The lifting platform as claimed in claim 1, wherein the displays (15; 151) comprise light-emitting diodes.

5. The lifting platform as claimed in claim 1, wherein each said sensor arrangement (14) comprises a matrix sensor (20) having a large number of sensor cells which are arranged in a matrix.

6. The lifting platform as claimed in claim 5, wherein each said display (15) has multicolor lighting, and the lighting is arranged in the matrix sensor (20) of corresponding matrix form.

7. The lifting platform as claimed in claim 6, wherein the sensor cells comprise piezoresistive sensors.

8. The lifting platform as claimed in claim 1, wherein the sensor arrangement (14) comprises a film-type sensor (20) which comprises at least two films (21, 22) to which conductor tracks (23) are applied, and the conductor tracks (23) of the two films (21, 22) cross over each other at crossover points, and the crossover points form sensor cells.

9. The lifting platform as claimed in claim 1, wherein the carrying plates (3a, 4a, 5a, 6a; 10; 100) each have a plate-shaped carrying structure (11; 110) and a rubber-elastic support (13; 130) is arranged above said carrying structure, and the sensor arrangement (151) is configured to detect a deformation of the elastic support (13; 130) under application of force.

10. The lifting platform as claimed in claim 9, further comprising a metal element (132) embedded into the elastic support of each of the carrying plates (3a, 4a, 5a, 6a; 10, 100), and the sensor arrangement (141) is configured to detect a change in distance between the element (132) and the carrying structure (100) under application of force.

11. The lifting platform as claimed in claim 9, wherein the sensor arrangement (141) is arranged between the elastic support (130) and the carrying structure (110).

12. The lifting platform as claimed in claim 10, wherein the sensor arrangement (141) has at least one coil and a measuring device (152) is provided for measuring a change in an inductance of the coil (141) due to a change in distance between the coil (151) and the metal element (132).

13. The lifting platform as claimed in claim 12, wherein the sensor arrangement comprises a plurality of said coils (141) which are arranged offset in a circumferential direction, and the coils (141) are printed onto a printed circuit board (140) which is arranged between the elastic support (130) and the carrying structure (110).

14. The lifting platform as claimed in claim 1, wherein the sensor arrangements (14; 141) and associated displays (15; 151) of the carrying plates (3a, 4a, 5a, 6a; 10; 100) are battery-operated.

15. The lifting platform as claimed in claim 1, wherein a total weight force which is applied to the associated carrying plate (3a, 4a, 5a, 6a; 10; 100) is ascertained from signals generated by the sensor arrangements (14; 141).

16. The lifting platform as claimed in claim 15, wherein the signals are adapted to be wirelessly transmitted to a central control arrangement.

17. A carrying plate (10; 100) for a vehicle lifting platform comprising a weight force sensor arrangement (14; 141) for recording a weight force which acts on the carrying plate (10; 100), the sensor arrangement (14; 141) comprising a plurality of pressure sensors arranged distributed over a bearing surface of the carrying plate (10; 100), and a display (15; 151) associated with the carrying plate (10; 100), said display being arranged on a bottom side of said carrying plate and being configured to display a pressure distribution over the bearing surface of the carrying plate (10; 100).
